(19) United States
(12) Patent Application Publication
(10) Pub. No.: US 2012/0285364 A1
(43) Pub. Date: Nov. 15, 2012

(54) FLAG MOUNTING DEVICE FOR A VEHICLE VENT VISOR

(76) Inventor: DeLoren Kanagy, Aiken, SC (US)

(21) Appl. No.: 13/105,474

(22) Filed: May 11, 2011

(51) Int. Cl. G09F 17/00

(52) U.S. Cl. 116/173

(57) ABSTRACT

A flag mounting device permits the window to be open when the flag is in use. In addition, the present invention provides a flag mounting device that may be used on vehicles having window vent visors. The flag mounting device includes a main body having an opening. The opening is adapted to receive a flag. The flag mounting device is adapted to be mounted to a window frame of a vehicle.

### BACKGROUND OF THE INVENTION

The present invention generally relates to a flag-mounting device. More particularly, the present invention relates to a flag-mounting device for use on a window of a vehicle.

Attaching flags, particularly American flags and flags supporting sports teams, to a vehicle is a common practice among vehicle owners. One popular method of attaching the flag to a vehicle is using a bracket that fits over the upper edge of a vehicle window. Unfortunately, the known brackets cannot be used on windows that have window vent visors.

As can be seen, there is a need to provide a device for mounting a flag on a vehicle that may be used on vehicles having window vent visors.

### SUMMARY OF THE INVENTION

In one aspect of the present invention, a flag mounting device includes a main body having an opening, the opening is adapted to receive a flag, and the flag mounting device is adapted to be mounted to a window frame of a vehicle.

These and other features, aspects and advantages of the present invention will become better understood with reference to the following drawings, description and claims.

### BRIEF DESCRIPTION OF THE DRAWINGS

FIG. 1 illustrates a perspective front view of a vehicle having a flag mounting device according to an exemplary embodiment of the present invention;

FIG. 2 illustrates an exploded view of the flag mounting device of FIG. 1;

FIG. 3 illustrates a cross-sectional view of the flag mounting device taken along line 3-3 in FIG. 2 showing the flag in a working position; and

FIG. 4 illustrates a sectional view of the flag mounting device of FIG. 2 showing a plug when the flag is not in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a flag mounting device that may be used on vehicles having window vent visors.

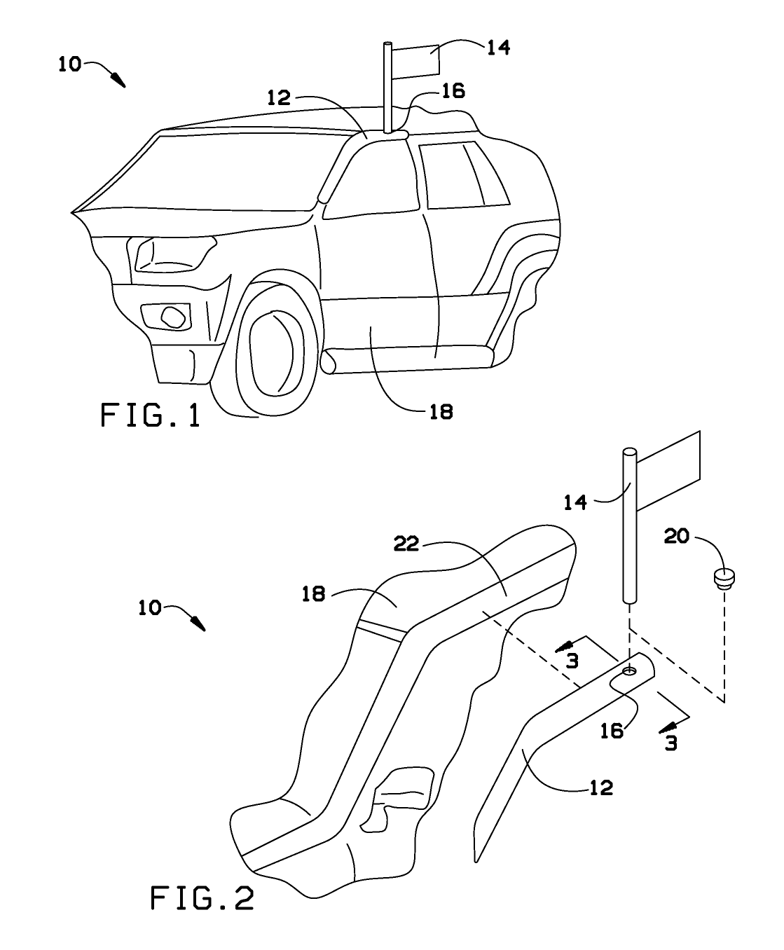

FIGS. 1-4 illustrate a vehicle 18 having a flag mounting device 10 according to an exemplary embodiment of the present invention. The flag mounting device 10 may be adapted to be mounted to a window frame 22 of the window 24. A flag 14 may be secured to the flag mounting device 10.

As can be seen on FIG. 2, the flag mounting device 10 may include a main body 12 having an opening 16. The opening 16 may be adapted to receive a flag 14. A cap 20 may be used to cover the opening 16 when the flag 14 is not being used.

The main body 12 may have a shape that may match the shape of the top end of the window frame 22. In some embodiments, the main body 12 may have the shape of a window wind visor, a window rain guard, or a window wind deflector. The main body 12 may be a unitary piece. The main body 12 may be made of a sturdy and corrosion-resistant material. In some embodiments, the main body 12 may be made of plastic, polymeric material, stainless steel, or composite material. The main body 12 may be made by injection molding or machinery.

The opening 16 may be located on the top side of the main body 12.

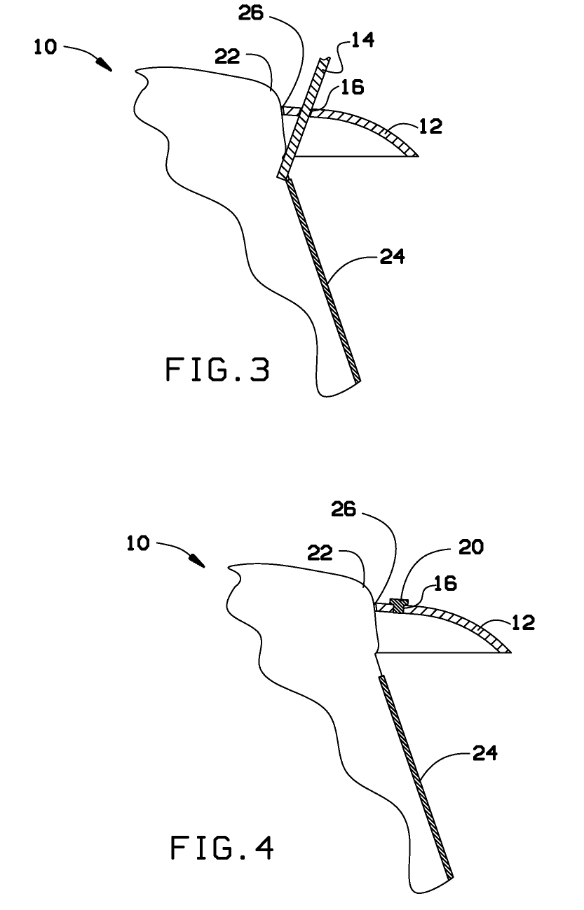

FIG. 3 shows that the opening 16 may allow the user to secure the flag 16 into the main body 12. The size of the opening 16 may depend on the size of the flag 14. In some embodiments, the opening 16 may have a diameter of 1 inch.

FIG. 4 shows that the cap 20 may be used to seal the opening 16 when the flag 14 is not in use. The size of the cap may depend on the size of the opening 16. The cap 20 may be made of an elastomeric material. In some embodiments, the cap 20 may be made of rubber, elastomeric plastic, vinyl, or silicone. The cap 20 may have a shape resembling a grommet, a plug, a T-plug, pull-plug, or a disk.

The main body 12 may be secured to the window frame 22 by using a fastener 26. The fastener 26 may be glue, an adhesive tape, or a hook and loop fastener. In some embodiments, the adhesive material may be a double-sided tape. In some embodiments, the main body 12 may be fixed to the window frame 22 by welding.

A pair of stoppers (not shown) may be placed inside the main body 12 to prevent the flag 14 from moving laterally.

The present invention may be sold as a kit including the main body 12 with the opening 16 and the cap 20.

It should be understood, of course, that the foregoing relates to exemplary embodiments of the invention and that modifications may be made without departing from the spirit and scope of the invention as set forth in the following claims.

What is claimed is:

1. A flag mounting device comprising:
a main body having an opening,
wherein the opening is adapted to receive a flag; and
wherein the flag mounting device is adapted to be mounted to a window frame of a vehicle.

2. The flag mounting device according to claim 1, further including a cap to cover the opening when the flag is not being used.

3. The flag mounting device according to claim 1, wherein the main body has a shape of a window wind visor, a window rain guard, or a window wind deflector.

4. The flag mounting device according to claim 1, wherein the opening is located on a top side of the main body.

5. The flag mounting device according to claim 2, wherein the cap is a grommet, a plug, a T-plug, a pull-plug, or a disk.

6. The flag mounting device according to claim 1, further including a fastener to secure the flag mounting device to the window frame.

7. The flag mounting device according to claim 6, wherein the fastener is selected from glue, an adhesive tape, or a hook and loop fastener.

8. The flag mounting device according to claim 6, wherein the fastener is a double-sided tape.

9. The flag mounting device according to claim 1, further including a pair of stoppers located inside the main body to prevent the flag from moving laterally.
